(19) United States
(12) Patent Application Publication
(10) Pub. No.: US 2015/0086048 A1
(43) Pub. Date: Mar. 26, 2015

(54) ACOUSTIC PANELS AND PLANAR STRUCTURES

(71) Applicant: CORNING INCORPORATED, Corning, NY (US)

(72) Inventors: Gordon Charles Brown, Corning, NY (US); John Phillip Ertel, Half Moon Bay, CA (US); David Ralph Maack, Horseheads, NY (US); Steven Luther Moyer, Lancaster, PA (US); Christopher Alan Nitz, Painted Post, NY (US); Zhiqiang Shi, Shrewsbury, MA (US)

(21) Appl. No.: 14/487,841

(22) Filed: Sep. 16, 2014

Related U.S. Application Data
(60) Provisional application No. 61/880,379, filed on Sep. 20, 2013.

(51) Int. Cl. H04R 1/02

(52) U.S. Cl. CPC H04R 1/02
USPC 381/152

(57) ABSTRACT

A glass panel is provided having a glass structure with an exterior surface and an interior surface, the glass structure having at least one glass sheet with a thickness ranging from about 0.5 mm to about 2.0 mm and a backing frame positioned adjacent the glass structure and situated along the perimeter of the interior surface of the glass structure. The glass panel further includes a polymer layer positioned on the interior surface and intermediate the glass structure and backing frame to adhere the glass structure together with the backing frame an array of acoustic exciters positioned on the glass structure, the array of acoustic exciters providing excitation energy to or receiving excitation energy from the glass structure where frequency response of the panel can be a function of the geometry of the glass structure and the position of the acoustic exciters.

This application claims the benefit of priority to U.S. Application No. 61/880,379 filed on Sep. 20, 2013 the content of which is incorporated herein by reference in its entirety.

### BACKGROUND

In conventional elevators, lobbies and other interior architectural environments, glass can be utilized as a wall covering or as the wall. In such environments, soda lime glass or tempered monolithic glass is typically utilized having thicknesses greater than about 6 mm. Laminated glass structures are also employed in such settings with multiple glass layers, each layer also having thicknesses greater than about 6 mm and resulting in an overall laminate glass structure thickness of over 12 mm or more. Furthermore, conventional decoration can employ soda lime glass or tempered monolithic glass mounted over wood, stone or another decorative surface or substrate. Notably, the weight of such wall coverings and/or glass paneling can be rather heavy and on the order of approximately five to ten pounds per square foot. Additionally, such thick glass or glass laminate structures combined with an underlying wood, stone or other substrate greatly increases the weight of the overall wall covering or panel.

In an elevator environment, weight is a notable issue where the trend has been towards lighter elevator cabs. Light-weight elevator cabs, however, generally reduce the load on a respective elevator motor and can allow for installation of smaller motors. Conventionally, this weight issue has been addressed by reducing weight in the elevator cab body and elevator cab framework. This solution, however, has failed to address weight savings provided by interior components of the elevator cab.

Additionally, conventional architectural and elevator solutions provide audio systems that utilize traditional cone or piezo speakers of discrete form. Such systems, however, fail to provide a planar surface having visual and/or audio features which are integrated into the walls, e.g., no visible holes, cutouts, or other obtrusive exposures to occupants of the space. Thus, there is a need to provide a light-weight solution which meets building safety codes and enables an acoustic panel to provide efficient sound reproduction and/or provide sound detection or two way communication with personnel in the respective space.

### SUMMARY

The present disclosure generally relates to interior architectural elements and the design and manufacture of light-weight, modular, reconfigurable glass panels having acoustic capabilities.

In some embodiments, thin glass panels and thin glass can be utilized to provide an acoustic speaker product for architectural spaces including, but not limited to, lobbies, hallways, office spaces, elevator cabs and other interior architecture wall panels as well as exterior architectural wall panels. In other embodiments, an exemplary glass acoustic panel can be excited by an energetic activation of a transducer via a sound source, e.g., radio, receiver, audio, video feed, amplifier, preamplifier, or equalizer, or the like. This energetic activation can vibrate the glass panel to generate sound pressure waves detectable by occupants of the respective space. Exemplary thin glass, thin glass panels, and laminates thereof can be formed of chemically strengthened glass (e.g., Gorilla® Glass) or other thin glass, alone or with a polymeric interlayer or adhesive such as, but not limited to, polyvinyl butryal (PVB) (DuPont Butacite, Saflex Vanceva, etc.), ethylene vinyl acetate (EVA) or other vinyls (Oracal, 3M, BeinHeim, etc.), SentryGlass® or other ionomers, polymers (including anti-splinter films or safety films), polycarbonate, acrylics, and the like.

In some embodiments, a glass panel is provided having a glass structure with an exterior surface and an interior surface, the glass structure having at least one thin glass sheet with a thickness ranging from about 0.5 mm to about 2.0 mm and a backing frame positioned adjacent the glass structure and situated along the perimeter of the interior surface of the glass structure. The glass panel further includes a polymer layer positioned on the interior surface and intermediate the glass structure and backing frame to adhere the glass structure together with the backing frame and an acoustic exciter positioned on the glass structure, the acoustic exciter providing excitation energy to or receiving excitation energy from the glass structure.

In other embodiments, a glass panel is provided having a glass structure with an exterior surface and an interior surface, the glass structure having at least one thin glass sheet with a thickness ranging from about 0.5 mm to about 2.0 mm and a backing frame positioned adjacent the glass structure and situated along the perimeter of the interior surface of the glass structure. The glass panel further includes a polymer layer positioned on the interior surface and intermediate the glass structure and backing frame to adhere the glass structure together with the backing frame an array of acoustic exciters positioned on the glass structure, the array of acoustic exciters providing excitation energy to or receiving excitation energy from the glass structure where frequency response of the panel can be a function of the geometry of the glass structure and the position of the acoustic exciters.

It is to be understood that both the foregoing general description and the following detailed description present embodiments of the present disclosure, and are intended to provide an overview or framework for understanding the nature and character of the claimed subject matter. The accompanying drawings are included to provide a further understanding of the present disclosure, and are incorporated into and constitute a part of this specification. The drawings illustrate various embodiments and together with the description serve to explain the principles and operations of the claimed subject matter.

### BRIEF DESCRIPTION OF THE DRAWINGS

For the purposes of illustration, there are several forms shown in the drawings, however, the embodiments disclosed and discussed herein are not limited to the precise arrangements and instrumentalities shown.

FIGS. 1A and 1B are perspective cut-away illustrations of embodiments of the present disclosure.

FIG. 2A is a top plan view of another embodiment of the present disclosure.

FIG. 2B is a cross-sectional view of the embodiment of FIG. 2A along line A-A.

FIG. 2C is a detailed view of FIG. 2B.

FIGS. 3A and 3B are detailed views, similar to FIG. 2C, of further embodiments of the present disclosure.

FIG. 4A is a top plan view of another embodiment of the present disclosure.

FIG. 4B is a cross-sectional view of the embodiment of FIG. 4A along line A-A.

FIG. 5 is an illustration of the impulse response for the embodiment of FIG. 4A.

FIG. 6 is an illustration of the frequency response for the embodiment of FIG. 4A.

FIG. 7 is a cumulative spectral decay waterfall plot for the embodiment of FIG. 4A for the impulse illustrated in FIG. 5.

FIG. 8 is a comparative illustration of the frequency response between thin, chemically strengthened glass and soda lime glass.

FIG. 9 is an illustration of some embodiments of the present disclosure.

FIG. 10 is a comparative illustration of frequency response between laminated glass structures and glass structures.

### DETAILED DESCRIPTION

With reference to the figures, where like elements have been given like numerical designations to facilitate an understanding of the present disclosure, the various embodiments for modular wall panels and planar structures are described.

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, it is understood that the group may comprise, consist essentially of, or consist of any number of those elements recited, either individually or in combination with each other.

Similarly, whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range. As used herein, the indefinite articles “a,” and “an,” and the corresponding definite article “the” mean “at least one” or “one or more,” unless otherwise specified

The following description of the present disclosure is provided as an enabling teaching thereof and its best, currently-known embodiment. Those skilled in the art will recognize that many changes can be made to the embodiment described herein while still obtaining the beneficial results of the present disclosure. It will also be apparent that some of the desired benefits of the present disclosure can be obtained by selecting some of the features of the present disclosure without utilizing other features. Accordingly, those of ordinary skill in the art will recognize that many modifications and adaptations of the present disclosure are possible and can even be desirable in certain circumstances and are part of the present disclosure. Thus, the following description is provided as illustrative of the principles of the present disclosure and not in limitation thereof.

Those skilled in the art will appreciate that many modifications to the exemplary embodiments described herein are possible without departing from the spirit and scope of the present disclosure. Thus, the description is not intended and should not be construed to be limited to the examples given but should be granted the full breadth of protection afforded by the appended claims and equivalents thereto. In addition, it is possible to use some of the features of the present disclosure without the corresponding use of other features. Accordingly, the foregoing description of exemplary or illustrative embodiments is provided for the purpose of illustrating the principles of the present disclosure and not in limitation thereof and can include modification thereto and permutations thereof.

In some embodiments of the present disclosure, thin sheets of glass can be employed as a surface mount on exemplary backing devices or frames or can be employed as single sheets or as laminate structures without backing devices or frames, or as combinations thereof. Such a structure can generally be referred to as a panel. Exemplary glass sheets can be formed from chemically-strengthened glass, thermal tempered glass, heat strengthened glass, annealed glass, soda lime glass, and glass ceramics, just to name a few. Additionally, embodiments of the present disclosure can employ exemplary polymers or plastics in the place of glass sheets. Exemplary polymeric materials include, but are not limited to, polyvinyl butryal (PVB), ethylene vinyl acetate (EVA), SentryGlass® or other ionomers, polycarbonate, acrylic, and the like. Exemplary glass or polymeric panels can be suitable for a myriad of interior or exterior environments such as, but not limited to, elevators, walls, standalone walls (as in partitions), office spaces, lab spaces, entry ways, and the like.

In additional embodiments of the present disclosure, thin chemically strengthened glass, e.g., Gorilla® Glass, can be employed over a decorative element, or with an integrated decorative element, to provide a light-weight solution to architectural requirements while providing benefits of durability and scratch and damage resistant surfaces to the underlying decoration or other components such as, but not limited to, acoustic transducers and the like. Applicant has discovered that by replacing conventionally employed glass products with thin, chemically-strengthened glass the weight of the respective device or panel is reduced by at least 50% without compromising the safety or impact performance of the device or panel. Additionally, by employing such light-weight and thin glass elements, touch functionality, acoustic functionality, and wireless communication functionality can be employed in embodiments of the present disclosure.

Suitable glass sheets used in embodiments of the present disclosure, whether in a single glass sheet embodiment or in a multi-layer glass sheet embodiment and used as an external and/or internal glass structure, can be strengthened or chemically-strengthened by a pre- or post-ion exchange process. In this process, typically by immersion of the glass sheet into a molten salt bath for a predetermined period of time, ions at or near the surface of the glass sheet are exchanged for larger metal ions from the salt bath. In one embodiment, the temperature of the molten salt bath is about 430° C. and the predetermined time period is about eight hours. The incorporation of the larger ions into the glass strengthens the sheet by creating a compressive stress in a near surface region. A corresponding tensile stress is induced within a central region of the glass to balance the compressive stress.

Exemplary ion-exchangeable glasses that are suitable for forming glass sheets or glass laminates can be alkali aluminosilicate glasses or alkali aluminoborosilicate glasses, though other glass compositions are contemplated. As used herein, “ion exchangeable” means that a glass is capable of exchanging cations located at or near the surface of the glass with cations of the same valence that are either larger or smaller in size. One exemplary glass composition comprises SiO₂, B₂O₃ and Na₂O, where (SiO₂+B₂O₃)≧66 mol. %, and Na₂₀≧9 mol. %. In an embodiment, the glass sheets include at least 6 wt. % aluminum oxide. In a further embodiment, a glass sheet includes one or more alkaline earth oxides, such that a content of alkaline earth oxides is at least 5 wt. %. Suitable glass compositions, in some embodiments, further comprise at least one of K₂O, MgO, and CaO. In a particular embodiment, the glass can comprise 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

A further exemplary glass composition suitable for forming hybrid glass laminates comprises: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; where 12 mol. %≦(Li₂O+Na₂O+K₂O)≦20 mol. % and 0 mol. %≦(MgO+CaO)≦10 mol. %. A still further exemplary glass composition comprises: 63.5-66.5 mol. % SiO₂; 8-12 mol. % Al₂O₃; 0-3 mol. % B₂O₃; 0-5 mol. % Li₂O; 8-18 mol. % Na₂O; 0-5 mol. % K₂O; 1-7 mol. % MgO; 0-2.5 mol. % CaO; 0-3 mol. % ZrO₂; 0.05-0.25 mol. % SnO₂; 0.05-0.5 mol. % CeO₂; less than 50 ppm As₂O₃; and less than 50 ppm Sb₂O₃; where 14 mol. %≦(Li₂O+Na₂O+K₂O)≦18 mol. % and 2 mol. %≦(MgO+CaO)≦7 mol. %.

In a particular embodiment, an alkali aluminosilicate glass comprises alumina, at least one alkali metal and, in some embodiments, greater than 50 mol. % SiO₂, in other embodiments at least 58 mol. % SiO₂, and in still other embodiments at least 60 mol. % SiO₂, wherein the ratio

$$\frac{{Al}_{2} {O}_{3} + {B}_{2} {O}_{3}}{\sum modifiers} > 1 ,$$

where in the ratio the components are expressed in mol. % and the modifiers are alkali metal oxides. This glass, in particular embodiments, comprises, consists essentially of, or consists of: 58-72 mol. % SiO₂; 9-17 mol. % Al₂O₃; 2-12 mol. % B₂O₃; 8-16 mol. % Na₂O; and 0-4 mol. % K₂O, wherein the ratio

$$\frac{{Al}_{2} {O}_{3} + {B}_{2} {O}_{3}}{\sum modifiers} > 1.$$

In another embodiment, an alkali aluminosilicate glass comprises, consists essentially of, or consists of: 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO. In yet another embodiment, an alkali aluminosilicate glass substrate comprises, consists essentially of, or consists of: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; wherein 12 mol. %≦Li₂O+Na₂O+K₂O≦20 mol. % and 0 mol. %≦MgO+CaO≦10 mol. %. In still another embodiment, an alkali aluminosilicate glass comprises, consists essentially of, or consists of: 64-68 mol. % SiO₂; 12-16 mol. % Na₂O; 8-12 mol. % Al₂O₃; 0-3 mol. % B₂O₃; 2-5 mol. % K₂O; 4-6 mol. % MgO; and 0-5 mol. % CaO, wherein: 66 mol. % SiO₂+B₂O₃+CaO≦69 mol. %; Na₂O+K₂O+B₂O₃+MgO+CaO+SrO>10 mol. %; 5 mol. %≦MgO+CaO+SrO≦8 mol. %; (Na₂O+B₂O₃)— Al₂O₃≦2 mol. %; 2 mol. % Na₂O—Al₂O₃≦6 mol. %; and 4 mol. %≦(Na₂O+K₂O)— Al₂O₃≦10 mol. %.

Exemplary chemically-strengthened as well as non-chemically-strengthened glass, in some embodiments, can be batched with 0-2 mol. % of at least one fining agent selected from a group that includes Na₂SO₄, NaCl, NaF, NaBr, K₂SO₄, KCl, KF, KBr, and SnO₂. In one exemplary embodiment, sodium ions in exemplary chemically-strengthened glass can be replaced by potassium ions from the molten bath, though other alkali metal ions having a larger atomic radii, such as rubidium or cesium, can replace smaller alkali metal ions in the glass. According to particular embodiments, smaller alkali metal ions in the glass can be replaced by Ag⁺ ions. Similarly, other alkali metal salts such as, but not limited to, sulfates, halides, and the like may be used in the ion exchange process. The replacement of smaller ions by larger ions at a temperature below that at which the glass network can relax produces a distribution of ions across the surface of the glass that results in a stress profile. The larger volume of the incoming ion produces a compressive stress (CS) on the surface and tension (central tension, or CT) in the center of the glass. The compressive stress is related to the central tension by the following relationship:

$$CS = CT ( \frac{t - 2 DOL}{DOL} )$$

where t represents the total thickness of the glass sheet and DOL is the depth of exchange, also referred to as depth of layer.

According to various embodiments, glass sheets and/or glass laminate structures comprising ion-exchanged glass can possess an array of desired properties, including low weight, high impact resistance, and improved sound attenuation. In one embodiment, a chemically-strengthened glass sheet can have a surface compressive stress of at least 250 MPa, e.g., at least 250, 300, 400, 450, 500, 550, 600, 650, 700, 750 or 800 MPa, a depth of layer at least about 20 μm (e.g., at least about 20, 25, 30, 35, 40, 45, or 50 μm) and/or a central tension greater than 40 MPa (e.g., greater than 40, 45, or 50 MPa) but less than 100 MPa (e.g., less than 100, 95, 90, 85, 80, 75, 70, 65, 60, or 55 MPa). A modulus of elasticity of a chemically-strengthened glass sheet can range from about 60 GPa to 85 GPa (e.g., 60, 65, 70, 75, 80 or 85 GPa). The modulus of elasticity of the glass sheet(s) and the polymer interlayer can affect both the mechanical properties (e.g., deflection and strength) and the acoustic performance (e.g., transmission loss) of the resulting glass laminate.

Exemplary glass sheet forming methods include fusion draw and slot draw processes, which are each examples of a down-draw process, as well as float processes. These methods can be used to form both chemically-strengthened and non-chemically-strengthened glass sheets. The fusion draw process generally uses a drawing tank that has a channel for accepting molten glass raw material. The channel has weirs that are open at the top along the length of the channel on both sides of the channel. When the channel fills with molten material, the molten glass overflows the weirs. Due to gravity, the molten glass flows down the outside surfaces of the drawing tank. These outside surfaces extend down and inwardly so that they join at an edge below the drawing tank. The two flowing glass surfaces join at this edge to fuse and form a single flowing sheet. The fusion draw method offers the advantage that, because the two glass films flowing over the channel fuse together, neither outside surface of the resulting glass sheet comes in contact with any part of the apparatus. Thus, the surface properties of the fusion drawn glass sheet are not affected by such contact.

The slot draw method is distinct from the fusion draw method. Here the molten raw material glass is provided to a drawing tank. The bottom of the drawing tank has an open slot with a nozzle that extends the length of the slot. The molten glass flows through the slot/nozzle and is drawn downward as a continuous sheet and into an annealing region. The slot draw process can provide a thinner sheet than the fusion draw process because a single sheet is drawn through the slot, rather than two sheets being fused together.

Down-draw processes produce glass sheets having a uniform thickness that possess surfaces that are relatively pristine. Because the strength of the glass surface is controlled by the amount and size of surface flaws, a pristine surface that has had minimal contact has a higher initial strength. When this high strength glass is then chemically strengthened, the resultant strength can be higher than that of a surface that has been a lapped and polished. Down-drawn glass may be drawn to a thickness of less than about 2 mm. In addition, down drawn glass has a very flat, smooth surface that can be used in its final application without costly grinding and polishing.

In the float glass method, a sheet of glass that may be characterized by smooth surfaces and uniform thickness is made by floating molten glass on a bed of molten metal, typically tin. In an exemplary process, molten glass that is fed onto the surface of the molten tin bed forms a floating ribbon. As the glass ribbon flows along the tin bath, the temperature is gradually decreased until a solid glass sheet can be lifted from the tin onto rollers. Once off the bath, the glass sheet can be cooled further and annealed to reduce internal stress.

As noted above, exemplary glass sheets can be used to form glass laminates or glass laminate structures. The term “thin” as used herein means a thickness of up to about 1.5 mm, up to about 1.0 mm, up to about 0.7 mm, or in a range of from about 0.5 mm to about 1.0 mm, or from about 0.5 mm to about 0.7 mm. The terms “sheet”, “structure”, “glass structures”, “laminate structures” and “glass laminate structures” may be used interchangeably in the present disclosure and such use should not limit the scope of the claims appended herewith. As defined herein, a glass laminate can also comprise an externally or internally-facing chemically-strengthened glass sheet, an internally or externally facing non-chemically-strengthened glass sheet, and a polymer interlayer formed between the glass sheets. The polymer interlayer can comprise a monolithic polymer sheet, a multilayer polymer sheet, or a composite polymer sheet. The polymer interlayer can be, for example, a plasticized poly(vinyl butyral) sheet.

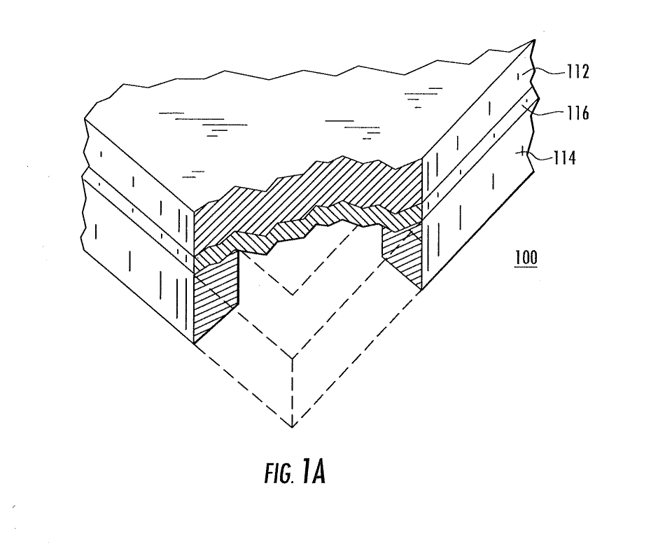

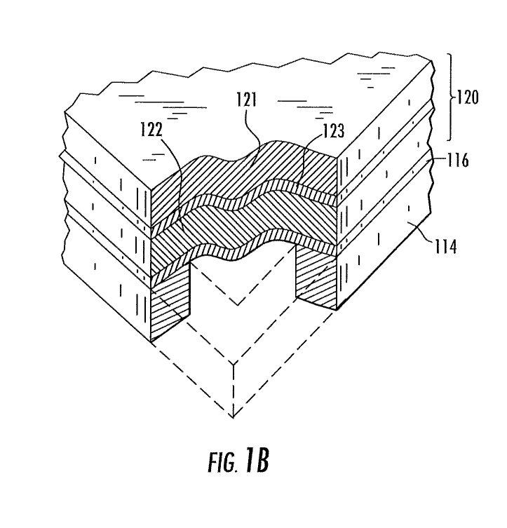

FIGS. 1A and 1B are perspective cut-away illustrations of embodiments of the present disclosure. With reference to FIG. 1A, an exemplary modular glass panel 100 includes a single, thin light-weight sheet of chemically-strengthened glass 112, e.g., Gorilla® Glass, mounted to a backing frame 114 by one or more adhesive materials 116. Of course, exemplary sheets of glass 112 can be formed from any suitable chemically-strengthened glass, thermal tempered glass, heat strengthened glass, annealed glass, soda lime glass, or glass ceramic, just to name a few. Additionally, embodiments of the present disclosure can employ exemplary polymers or plastics in the place of glass sheets. Exemplary polymeric materials include, but are not limited to, polyvinyl butryal (PVB), ethylene vinyl acetate (EVA) or other vinyls, SentryGlass® or other ionomers, polycarbonate, acrylic, polymers (including anti-splinter films, safety films and optically clear adhesive films), and the like. Exemplary glass or polymeric panels can be suitable for a myriad of interior or exterior environments such as, but not limited to, elevators, walls, standalone walls (as in partitions), office spaces, lab spaces, entry ways, and the like. While FIG. 1A illustrates a single sheet of material or glass 112, embodiments of the present disclosure should not be so limited as a multi-layer structure 120 can also be mounted onto a suitable backing frame 114 as illustrated in FIG. 1B.

An exemplary, non-limiting backing frame or structure 114, 117 can be constructed of a piece or multiple pieces of material having a modulus of elasticity >2 GPa and a thickness greater than 3 mm. Exemplary backer materials include, but are not limited to, polyvinyl chloride (PVC), polycarbonate, phenolic materials (e.g., Trespa and the like), steel, wood, aluminum, glasses (e.g., soda lime glass and the like), ceramics, other metals, etc. These backer materials can be in the form of a frame as in FIGS. 1A and 1B. In alternative embodiments, the backing frame (as in FIGS. 1A and 1B) can be in the form of a honeycomb or has a honeycomb structure. Exemplary materials for the honeycomb backer can be, but is not limited to, aluminum, steel, ceramic, polymer, graphite, carbon, and combinations thereof.

With continued reference to FIG. 1B, the multilayer structure 120 can include one thin glass sheet 121 and a second glass sheet 122 having a polymer interlayer 123 therebetween. Exemplary glass sheets 121, 122 can be formed from any suitable chemically-strengthened glass, thermal tempered glass, heat strengthened glass, annealed glass, soda lime glass, and glass ceramics, just to name a few. In some embodiments, the first or external glass sheet 121 can be chemically strengthened glass and the second or interior glass sheet 122 can be non-chemically strengthened. Of course, embodiments of the present disclosure can employ exemplary polymers or plastics in the place of the glass sheets. Exemplary polymeric materials include, but are not limited to, polyvinyl butryal (PVB), ethylene vinyl acetate (EVA), SentryGlass® or other isomers, polycarbonate, acrylic, and the like. Exemplary embodiments depicted in FIGS. 1A-1B can include chemically strengthened glass sheets or glass laminate structures bonded with one or more layers of an anti-splinter, adhesive film 116 to the backing frame 114 or full backing structure 117. Additional glasses, coatings, and/or glass ceramics can be employed in embodiments of the present disclosure to provide a variety of optical characteristics such as, but not limited to, varying transparency characteristics (e.g., active devices such as, but not limited to, electrochromic and passive control such as photo or thermochromic control with heat and/or wavelength tuned control of transparency), anti-glare characteristics, anti-reflection characteristics, structural characteristics (embossments, inclusions, cold or hot formed structures), mirrored surfaces, electrical circuitry (printing or deposition of circuitry by screen printing, ink jet printing, ITO, vapor deposition and the like) for transparent displays and electroluminescent displays. In some embodiments, the film layer 116 can include a plurality of decorative or adhesive layers. Such decorative layers can be painted, ink jetted, or otherwise deposited directly on the glass sheet or glass laminate structure, deposited on a vinyl layer (either cast or calendered, with or without embossments in the adhesive layer for pathways of air escape during lamination), deposited on PVB such as Sentry Glass Expressions or other printable PVB, or deposited on other types of interlayers and films such as EVA or other vinyls, thermoplastic polyurethane (TPU), and polyethylene terephthalate (PET), ionomers, polymers, polycarbonates, acrylics, to name a few, with or without embossments in the adhesive layer for pathways of air escape during lamination.

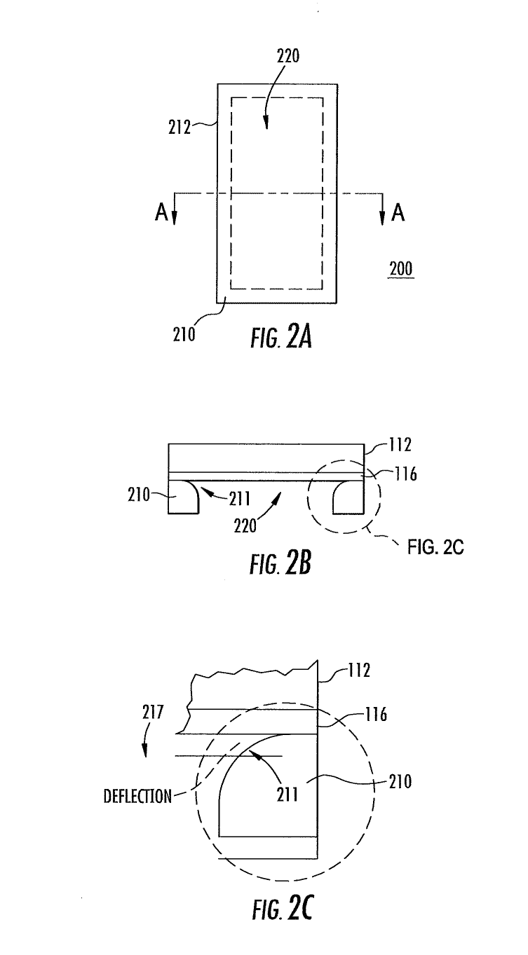

FIG. 2A is a top plan view of another embodiment of the present disclosure. FIG. 2B is a cross-sectional view of the embodiment of FIG. 2A along line A-A. FIG. 2C is a detailed view of FIG. 2B. With reference to FIGS. 2A-2C, an exemplary modular glass panel 200 can include one or more glass sheets or glass laminate structures as described above. While the modular glass panel 200 is illustrated in rectangular form, the claims appended herewith should not be so limited as exemplary modular glass panels 200 can be any geometric form such as, but not limited to, circular, oval, square, hexagonal, trapezoidal, etc. Additionally, it is envisioned that any glass panel shape, whether symmetrical or asymmetrical, can be cut and formed as appropriate and an exemplary backing panel affixed thereto. The modular glass panel 200 in this non-limiting embodiment can provide a backing frame 210 extending along the perimeter 212 of the glass panel. In some embodiments, the backing frame 210 can fully frame or enclose (e.g., a U- or C-shaped frame) the edges of the glass sheet 112 or laminate structure or, in other embodiments, can leave the edges thereof exposed whereby the edges of the glass sheet 112 or laminate structure overhang the backing frame 210 or are set back or flush with the edge of the backing frame 210. In some embodiments, the glass sheet 112 or laminate structure is substantially flush or set back from the backing frame 210 edge.

In additional embodiments of the present disclosure, the glass sheet 112 or laminate structure can be rendered to a safety glass. For example, exemplary glass sheets can be made as a safety glass by employing a suitable bonding polymer (e.g., a variety of 3M Safety Films are made for this purpose) on the rear or back side of the glass sheet. It also follows that laminated glass structures, e.g., glass-to-glass sheets or glass sheet to polymeric material to glass sheet are also examples of safety glasses. Exemplary, non-limiting constructions of glass paneling or laminate structure paneling include a glass/interlayer/glass construction with the interlayer comprising PVB, EVA, Sentry Glass, PET, or another energy absorbing or dispersing polymer. Such an embodiment has been experimentally tested and surpassed ANSI test requirements for resistance against impact and for retaining broken glass pieces when the respective panel was finally fractured. Such exemplary constructions can also accommodate any decorative, acoustic, and/or lighting qualities of the panel on a solid or framed backing device. In some exemplary embodiments having a backing frame, the space or area 220 defined or encompassed by the perimeter frame 210 permits the use of the glass or laminate panel as a speaker, receiver, microphone, and the like, whereby the acoustic actuators can be adhered to the interior of the glass panel and the respective acoustic components, e.g., amplifiers, transducers, and the like, contained within the encompassed area 220. Additionally, the glass or laminate panel can be utilized as a cover glass for touch screen devices mounted directly to the glass or glass laminate panel and substantially contained in the encompassed area 220. In further embodiments of the present disclosure, lighting devices and components such as, but not limited to, light emitting diodes (LEDs), arrays of LEDs, and other luminaires can be substantially contained in the encompassed area 220 whereby the light given therefrom is emitted through the glass or glass laminate panel. For example, in one embodiment, separate LED panels can be placed behind a glass panel (which may not be transparent but employs diffuse mechanisms (e.g., anti-glare coating on one or both sides of the panel, etched (dipped, sprayed, deposited)) or other structured light qualities incorporating a variety known decorative designs). In another embodiment, LED strips or individual LEDs can be positioned around the perimeter of an exemplary panel to use the glass or laminate structure as a waveguide, dispersing light such that the glass panel glows. Thus, in such embodiments, portions or all of the glass or glass laminate panel can include diffusing mechanisms including coatings or the like to diffuse or otherwise alter incident light on one side of the glass or glass laminate panel thereby providing an altered or diffused refracted light.

In some of these embodiments, the intensity of emitted light can be controlled by several mechanisms such as, but not limited to, dimmers, manual variable controls, voice, motion or heat activated controls (or other automated, computer controlled, manually controlled mechanisms) to reduce heat produced by radiant energy. To reduce or eliminate lighting “hot spots” (areas where people perceive the light source) and create a uniform lighting, the glass or laminate material can be etched to create a diffuse surface. For example, opal glass can be employed to produce uniform lighting for microscopy or photography or holography. Other means of creating uniform lighting through the use of holographic diffusers, chemical etchants, sand or bead blasting glass can also be employed in embodiments of the present disclosure. Diffusers can also be engineered to deliver or convert almost any type of diffusion profile from non-uniform output light sources such as LEDs. One exemplary non-limiting engineered diffuser includes a variable diffuser manufactured by Luminit, LLC. Exemplary diffusion profiles can range from narrow line to a broad Lambertian profile to homogenize non-uniform light emitted from many sources, including LEDs. Holographic, etched, and opal glass diffusers are generally available from such sources as Edmund Optics. Engineered diffusers are obtainable from RPC, Inc. In one embodiment, a diffusing panel can be placed between an LED panel contained in an encompassed area 220 and one of the glass panels affixed thereto by optically clear adhesives. In another embodiment, a diffuser element can be a part of the glass used in the panel. Diffusers so employed can thus be designed to modify lighting conditions across an exemplary panel to create unique patterns for decorative and/or functional lighting displays. Thus, in some embodiments the glass or glass laminate panel can also include a variety of materials selected for their unique properties in creating a light-weight, strong, visually appealing and user interactive panel.

In further embodiments, the front surface of the glass or glass laminate panel can provide a variety of attributes for aesthetics, safety, and user interaction. For example, the glass surface can include anti-glare, anti-reflection, anti-fingerprint, anti-viral, anti-bacterial or other coatings produced by mechanical or chemical means.

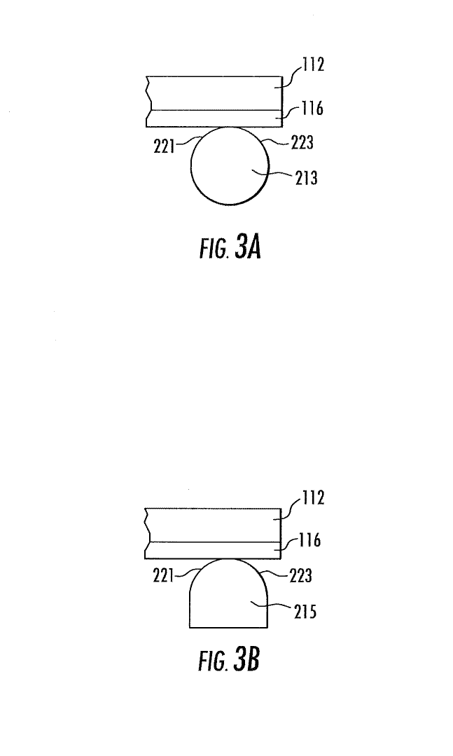

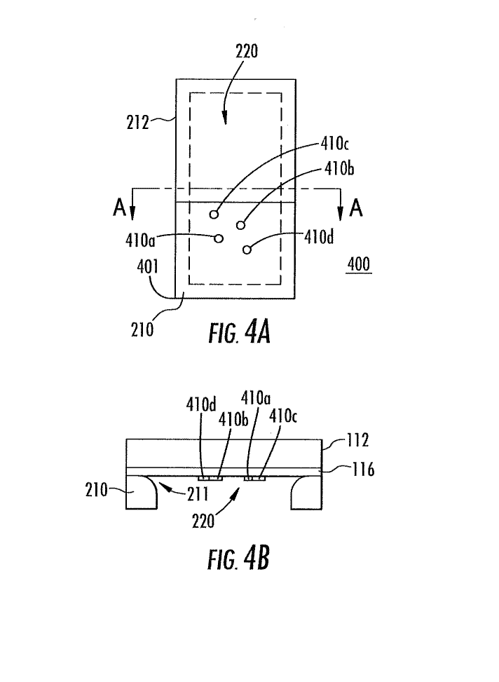

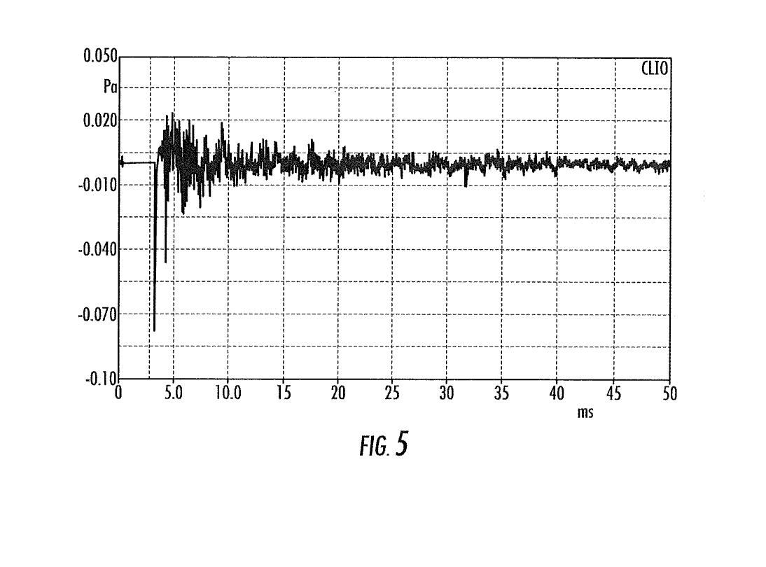

With continued reference to FIGS. 2B and 2C, an exemplary backing frame 210 can include a substantially rectangular or square cross section wherein an interior edge 211 thereof is rounded in form. This rounded edge 211 can accommodate any flexure, deflection or bending 217 of the glass or glass laminate panel and does not provide a sharp edge as would otherwise be present with a fully rectangular or square cross section. FIGS. 3A and 3B are detailed views, similar to FIG. 2C, of further embodiments of the present disclosure whereby the backing frame includes a circular 213 or domed 215 cross section. Again, in each of these embodiments, an interior edge 221 and in some cases exterior edge 223 presents a rounded form to prevent a sharp edge from contacting the adjacent glass panel or glass laminate structure. Of course, while the cross sectional geometries have been illustrated as rectangular or square (FIGS. 2B, 2C) with a rounded edge, or circular (FIG. 3A), or domed (FIG. 3B), the claims appended herewith should not be so limited as the cross section can be any number of geometries, e.g., oval, hexagonal, trapezoidal, asymmetrical, etc., so long as the edges of such geometric form are rounded on the interior edge of the backing frame. Of course, while the embodiments of the present disclosure have been illustrated as having a single glass sheet 112 adhered to a backing frame with an adhesive layer 116, the claims appended herewith should not be so limited as exemplary embodiments can include multilayer glass laminate structures described herein and illustrated in FIG. 1B. In embodiments of the present disclosure where the glass panel is not flush to the backing frame, both edges, the interior edge and exterior edge would present a rounded edge to the adjacent glass panel or laminate structure to prevent a sharp profile thereto. Additionally, while the cross-sectional illustrations are shown as solid core frame embodiments, it is envisioned that the frames can be hollow in nature thereby further reducing the weight of an exemplary modular panel. Thus, the claims appended herewith should not be so limited to a solid frame core. Such backing devices or frames can thus allow panelization of the glass or laminate board without the need for point supported hardware; however, embodiments of the present disclosure can also be point supported using a variety of common hardware options such as spider clamps and the like (e.g., non-penetrating, but through-holes are also envisioned).

In some embodiments, thin glass panels and thin glass can be utilized to provide an acoustic speaker product for architectural spaces including, but not limited to, lobbies, hallways, office spaces, elevator cabs and other interior architecture wall panels as well as exterior architectural wall panels. In other embodiments, an exemplary glass acoustic panel can be excited by an energetic activation of a transducer via a sound source, e.g., radio, receiver, audio, video feed, amplifier, preamplifier, or equalizer, or the like. This energetic activation can vibrate the glass panel to generate sound pressure waves detectable by occupants of the respective space. Exemplary thin glass, thin glass panels, and laminates thereof can be formed of chemically strengthened glass (e.g., Gorilla® Glass) or other thin glass, alone or with a polymeric interlayer or adhesive such as, but not limited to polyvinyl butryal (PVB) (DuPont Butacite, Saflex Vanceva, etc.), ethylene vinyl acetate (EVA) or other vinyls (Oracal, 3M, BeinHeim, etc.), SentryGlass® or other ionomers, polymers (including anti-splinter films or safety films), polycarbonate, acrylics, and the like.

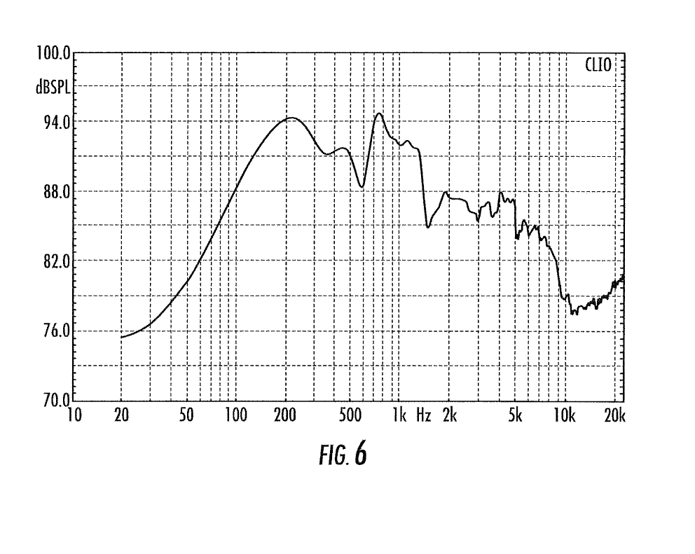

FIG. 4A is a top plan view of another embodiment of the present disclosure. FIG. 4B is a cross-sectional view of the embodiment of FIG. 4A along line A-A. With reference to FIGS. 4A-4B, an exemplary acoustic glass panel 400 can include one or more glass sheets or glass laminate structures as described above. While the acoustic glass panel 400 is illustrated in rectangular form, the claims appended herewith should not be so limited as exemplary acoustic glass panels 400 can be any geometric form such as, but not limited to, circular, oval, square, hexagonal, trapezoidal, etc. Additionally, it is envisioned that any glass panel shape, whether symmetrical or asymmetrical, can be cut and formed as appropriate and an exemplary backing panel affixed thereto. The acoustic glass panel 400 in this non-limiting embodiment can provide a backing frame 210 extending along the perimeter 212 of the glass panel. In some embodiments, the backing frame 210 can fully frame or enclose (e.g., a U- or C-shaped frame) the edges of the glass sheet 112 or laminate structure or, in other embodiments, can leave the edges thereof exposed whereby the edges of the glass sheet 112 or laminate structure overhang the backing frame 210 or are set back or flush with the edge of the backing frame 210. In some embodiments, the glass sheet 112 or laminate structure is substantially flush or set back from the backing frame 210 edge. In additional embodiments of the present disclosure, the glass sheet 112 or laminate structure can be rendered to a safety glass. For example, exemplary glass sheets can be made as a safety glass by employing a suitable bonding polymer (e.g., a variety of 3M Safety Films are made for this purpose) on the rear or back side of the glass sheet. It also follows that laminated glass structures, e.g., glass-to-glass sheets or glass sheet to polymeric material to glass sheet are also examples of safety glasses. Exemplary, non-limiting constructions of glass paneling or laminate structure paneling include a glass/interlayer/glass construction with the interlayer comprising PVB, EVA, Sentry Glass, PET, or another energy absorbing or dispersing polymer. Such an embodiment has been experimentally tested and surpassed ANSI test requirements for resistance against impact and for retaining broken glass pieces when the respective panel was finally fractured. Such exemplary constructions can also accommodate any decorative, acoustic, and/or lighting qualities of the panel 400. In some embodiments of the acoustic glass panel 400, the space or area 220 defined or encompassed by the perimeter frame 210 permits the use of the glass or laminate panel as a speaker, receiver, microphone, and the like, whereby the acoustic actuators or transducers 410a-410d can be adhered to the interior of the glass panel and the respective acoustic components, e.g., amplifiers, transducers, and the like, contained within the encompassed area 220. In other embodiments, the acoustic glass panel 400 can be excited by edge mounted transducers (not shown).

In some embodiments, exemplary adhesive or polymer layers 116 can be shaped, cut and positioned on the acoustic glass panel 400 to create functional and artistic design elements as part of a sound reproduction surface. Such polymer layers 116 can also be employed as an acoustic dampening mechanism and the position, composition, number of layers and/or thickness of the layer(s) 116 can vary as a function of the required or desired acoustic dampening. Exemplary acoustic glass panels 400 can be flat or shaped (i.e., bent) and can be any number of geometrical shapes as noted above. Furthermore, the thickness of the acoustic glass panel 400 (i.e., the thickness of the respective glass sheet(s) and polymer layer(s)) can be utilized to tune the acoustic glass panel 400 for specific effects such as, but not limited to, frequency response, impulse response, stereoscopic response, and the like. While not shown, stiffening partitions or munnions (i.e., mullions) can be employed to create isolated sub-speakers on an acoustic glass panel 400. Multiple acoustic panels 400 can also be employed in a predetermined space and any one or several of such panels can provide a mono, stereo, surround or other desired acoustic experience for occupants of the space.

In one experiment, an exemplary acoustic glass panel 400 was created using a glass laminate structure comprising a chemically strengthened glass sheet 112 (e.g., Gorilla® Glass) bonded to a polymer layer 16, in this case, a decorated vinyl of Oracal Orajet using a 3M optically clear adhesive film for anti-splinter purposes. Of course, any suitable polymer layer can be employed in embodiments of the present disclosure and such an example should not limit the scope of the claims appended herewith. This structure was then adhered to a suitable frame using double sided adhesive tape (e.g., 3M VHB). In this experiment, the exemplary, non-limiting acoustic glass panel included dimensions of 31 inches by 31 inches. Exciter or transducer 410 positions were determined as a function of panel geometry and transducer characteristics, and in this experiment, the transducer locations were positioned relative to a corner 401 of the acoustic glass panel 400 with a first transducer 410a positioned at 354 mm in the y-direction, 344 mm in the x-direction from the corner 401, a second transducer positioned 410b at 444 mm in the y-direction, 429 mm in the x-direction from the corner 401, a third transducer 410c positioned at 344-mm in the y-direction, 459 mm in the x-direction from the corner 401, and a fourth transducer 410d positioned at 504 mm in the y-direction, 339 mm in the x-direction from the corner 401. Two sets of B-ohm exciters or transducers 410a and 410d, 410b and 410c were electrically connected in series with the two sets connected in parallel to create a single 8-ohm impedance driven by an amplifier circuit. Of course, any suitable electrical connection can be utilized and such an example should not limit the scope of the claims appended herewith as the number, position, type, etc. of exciters or transducers can alter or flatten out the frequency response of an exemplary panel.

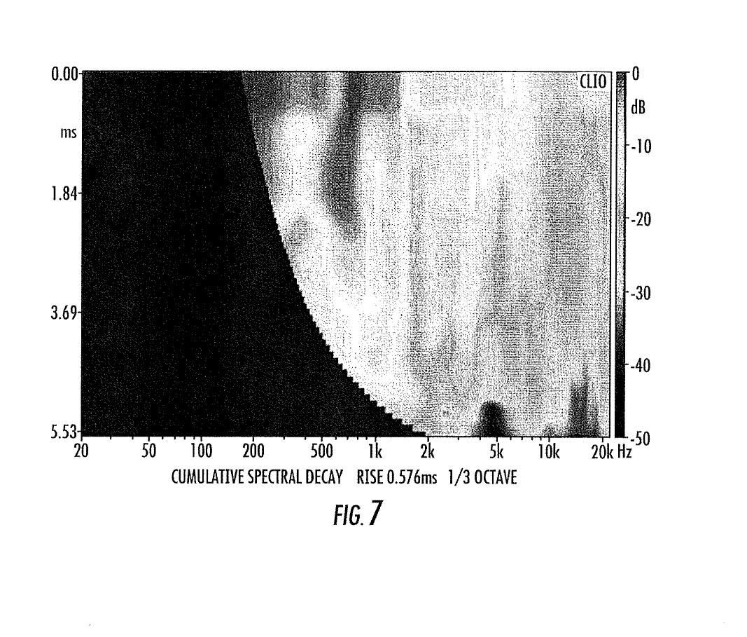

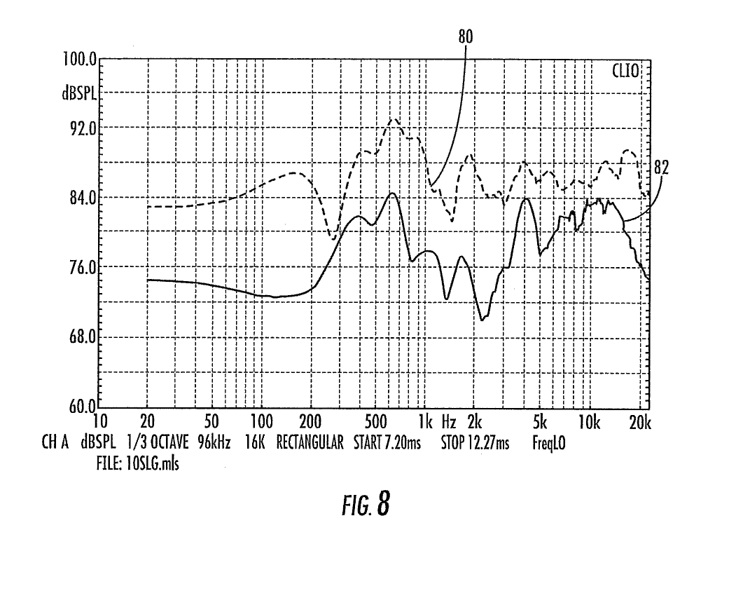

FIG. 5 is an illustration of the impulse response for the embodiment of FIG. 4A. FIG. 6 is an illustration of the frequency response for the embodiment of FIG. 4A. FIG. 7 is a cumulative spectral decay waterfall plot for the embodiment of FIG. 4A for the impulse illustrated in FIG. 5. With reference to FIGS. 5-7, a frequency of approximately 180.79 Hz was provided to the transducer configuration 410a-410d of FIG. 4A for an approximate 6 ms duration, e.g., from 2.83 ms to 8.36 ms whereby the illustrated impulse response of FIG. 5 resulted. FIG. 6 provides an illustration of the frequency response of this same transducer configuration; however, it follows that the use of different transducers and positions therefor can be utilized to improve the frequency response of embodiments of the present disclosure, thus this illustration and example should not limit the scope of the claims appended herewith. The cumulative spectral decay (CSD) waterfall plot (FIG. 7) of the panel 400 for the impulse shown in FIG. 5 illustrates the relative decay (time) or ringing of the panel at each frequency from 180.79 Hz to approximately 2 kHz over a 5.576 ms duration.

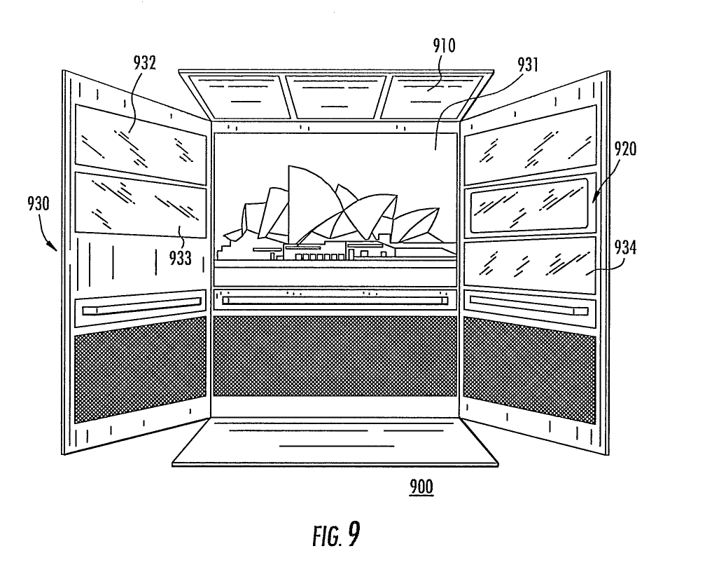

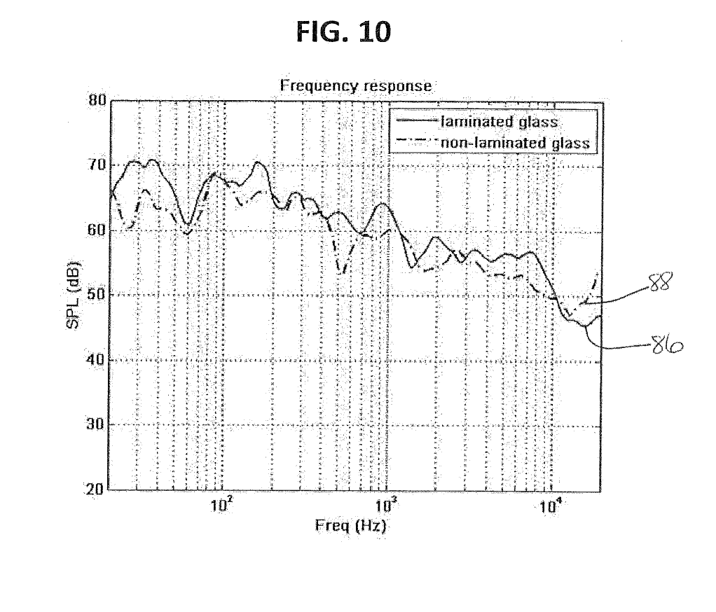

FIG. 8 is a comparative illustration of the frequency response between thin, chemically strengthened glass and soda lime glass. FIG. 10 is a comparative illustration of frequency response between laminated glass structures and glass structures. With reference to FIG. 8, an experiment was conducted to measure and compare the frequency response of a sheet of 0.7 mm chemically strengthened glass (e.g., Gorilla® Glass) 80 with a sheet of 2.0 mm soda lime glass 82 on an A4 size panel. The actuators or transducers were driven with identical inputs resulting in the frequency response illustrated in FIG. 8. The frequency response clearly illustrates that the thinner chemically strengthened glass can be easier to excite (i.e., possesses a greater efficiency) and provides a flatter response in a frequency range around 2000 Hz. Thus, exemplary acoustic glass panels 400 made with thin glass (e.g., Gorilla® Glass) can more accurately reproduce sounds and music than thicker, conventional glass speakers. Further, exemplary sounds for embodiments of the present disclosure can also include white, pink or other means for background noise masking. The thinness and clarity of exemplary glass panels can also enable efficient integration of novel lighting elements to the acoustic glass panel. Further, lighting elements (e.g., integrated lighting with LED, light diffusing fiber, back lighting, edge lighting, diffusing or other homogenizing panel materials) can be combined with the acoustic elements of the present disclosure to create static displays and/or dynamic displays synchronized with acoustics from the panel. With reference to FIG. 10, it can be observed that laminated glass structures 86 can provide an improved frequency response from non-laminated glass structures 88, e.g., less dip and a flatter response between about 2 to 8 kHz.

Embodiments of the present disclosure envision several mechanisms to excite exemplary acoustic glass panels. In some embodiments, discrete mechanical exciters or transducers, e.g. PZT, voice coil, magnet, motor, electrostatic, acousto-mechanical (e.g., transducers described in U.S. Pat. No. 6,720,708, the entirety of which is incorporated herein by reference), pneumatic, thermal, and air transfer transducers can be employed. Of course, other transducers are envisioned and such examples should not limit the scope of the claims appended herewith. For example, piezoelectric transducers can include PZT (Pb(Zr,Ti)O₃)-based transparent ceramics such as lanthanum-doped zirconium titanate (PLZT), (PbBa)(Zr,Ti)O₃, (PbSr)(ZrTi)O₃ and (PbCa)(ZrTi)O₃, barium titanate, or organic materials such as polyvinylidene fluoride (PVDF), poly-a-methyl-1-glutamate, polyvinyl chloride (PVC), poly tri-fluoro ethylene, or other suitable organic piezoelectric layers or materials. Exemplary transducers or exciters 410a-410d according to embodiments of the present disclosure can be attached to or made part of the glass panel 400 by physical attachment, coating mechanisms, wirelessly, etc. For example, exemplary transducers 410a-410d can be physically attached to the panel 400 through utilization of structural or engineering adhesives such as, but not limited to, silicones, urethanes, acrylates, isocyanoacetates, epoxies, and derivatives thereof, and through utilization of mechanical elements such as, but not limited to, screws, flexures, or other clamping mechanisms. Exemplary transducers or exciters can also be attached to either the face of the panel or edge of the panel and can partially or wholly encompass the respective edge or face of the panel. In alternative embodiments, the transducers can be injection molded as attachments for either edge or face components of an exemplary panel. In some embodiments, thin films can be utilized to make the transducers or exciters part of the glass panel, e.g., lithographically, lamination, coatings, additive, subtractive, and the like. Of course, embodiments of the present disclosure can utilize any combination of such coating mechanisms or physical attachment mechanisms to fine tune a panel and respective frame combination. Some embodiments can also excite a respective panel utilizing wireless (e.g. Bluetooth) or wired connections thereto.

Embodiments of the present disclosure can thus provide a multitude of features to precisely control sound output from a glass panel. For example, in some embodiments, signal processing or digital signal processing can be utilized to control the acoustics within a desired environment such as, but not limited to, an elevator cab, lobby, hallway, etc. Active or passive sound cancellation can be utilized to reduce or eliminate resonance with a specific acoustic glass panel and thus reduce or eliminate noise within an elevator, office, or other interior space. For example, in some embodiments, active noise cancellation (ANC) technology can be utilized in low-frequency ranges, e.g., below a few hundred Hertz which can be difficult to attenuate with passive sound cancellation mechanisms due to the wavelengths at these low frequencies. HVAC noise in buildings, elevator cabs, and the like generally falls within this low frequency range. Thus, exemplary acoustic glass panels can be utilized in a building's ANC system design to generate necessary background noise or “sound masking” in predetermined space(s). Embodiments of the present disclosure can also be utilized to localize sound in a predetermined space by, for example, triangulating emitted noise or sound, directing sound to specific zones, tuning the emitted noise or sound to the environment of a respective panel installation, etc.

It is also envisioned that embodiments of the present disclosure can provide more efficient sound reproduction, e.g., frequency response, as a function of the composition of the thin glass, the DOL of the respective chemically-strengthened glass, the levels of compressive stress in a glass sheet, the levels or differences in compressive stress between two layers of glass sheets in a laminate structure, the levels or differences in compressive stress in a single glass sheet, the geometry (e.g., lateral dimensions, configuration and thickness (see, e.g., FIG. 8)) of a glass sheet(s), laminate structure (see, e.g., FIG. 10), polymer interlayer or polymer layer, and the position, type, and number of transducers on the face and/or edge of a respective panel.

Embodiments of the present disclosure can thus be utilized to provide music and alerts to occupants of a space, e.g., elevator, office space, lobby, etc. and can also replace current alarm and alert systems within a single panel, i.e., replace conventional elevator alert systems which include cut panels or the like. Due to the nature of the transducers in embodiments of the present disclosure, two way communications can also be achieved by utilizing the panel transducers as both a speaker and a microphone thereby eliminating the need for cutting or drilling into panels.

As noted above, exemplary frames and enclosures for embodiments of the present disclosure can be any suitable frame or enclosure such as, but not limited to, an extruded aluminum or metal frame, a frame described in co-pending U.S. Application No. 61/869,291 the entirety of which is incorporated herein by reference, and other frames which provide adequate spacing for face-mounted or edge-mounted transducers and/or spacing for exemplary acoustic components. It should also be noted that the light-weight advantages of exemplary panels allow easier mounting with glues, tapes, or other chemical and mechanical means of affixing the glass or panel which can relax the stress placed on such materials when compared to thicker glasses. Suitable frame materials can include, but are not limited to, metals, plastics (soft, hard, foam, etc.), wood, fiberboard, and any other suitable injection molded, RIM, edge protected, direct mate frame material or framework. Also, as noted above, exemplary acoustic and modular glass panels can include anti-microbial, anti-glare, anti-fingerprint, anti-reflective, anti-splinter and other surface coatings or glazings. Furthermore, decorative elements can be applied to any surface of an exemplary without impairment of the sound quality or safety of the panel and can be applied through digital printing (of the glass or adhesive layer(s)), spray painting, silk screening, 3D printing, or any other suitable decorative application manner.

Additionally, the acoustic or modular glass or glass laminate panel illustrated in FIGS. 4A-4B can be utilized as a cover glass for touch screen devices mounted directly to the glass or glass laminate panel and substantially contained in the encompassed area 220. In further embodiments of the present disclosure, lighting devices and components such as, but not limited to, light emitting diodes (LEDs), arrays of LEDs, and other luminaires can be substantially contained in the encompassed area 220 whereby the light given therefrom is emitted through the glass or glass laminate panel and can, in some embodiments, be synchronized with any sound emitted from an acoustic embodiment. For example, in one embodiment, separate LED panels can be placed behind a glass panel (which may not be transparent but employs diffuse mechanisms (e.g., anti-glare coating on one or both sides of the panel, etched (dipped, sprayed, deposited)) or other structured light qualities incorporating a variety known decorative designs). In another embodiment, LED strips or individual LEDs can be positioned around the perimeter of an exemplary acoustic panel to use the glass or laminate structure as a waveguide, dispersing light such that the glass panel glows. Thus, in such embodiments, portions or all of the glass or glass laminate panel can include diffusing mechanisms including coatings or the like to diffuse or otherwise alter incident light on one side of the glass or glass laminate panel thereby providing an altered or diffused refracted light. Such light can also be synchronized with outputted acoustics if so desired.

FIG. 9 is an illustration of some embodiments of the present disclosure. With reference to FIG. 9, a series of planar surfaces 900 is presented having embodiments of the present disclosure mounted thereon. In some embodiments, these planar surfaces 900 can form one or more walls and/or a ceiling in an elevator cab. In other embodiments, these planar surfaces 900 can form walls or other surfaces in a lobby, room or other interior or exterior environment. More specifically, FIG. 9 provides an exemplary system of panels incorporating high resolution mural graphics, diffuse lighting panels (ceiling or wall), solid colors, wood and steel vignettes, touch screen information devices, and acoustic panels that can operate as speakers or microphones and/or include wireless or wired control of lighting, sound systems, interactive videos, and data transfer (e.g., Bluetooth) to hand held devices. It should be noted that the depiction of the planar surfaces 900 in a confined area should not limit the scope of the claims appended herewith. As depicted in FIG. 9, modular glass panels according to embodiments of the present disclosure can be employed along vertical, horizontal or other planar surfaces of a structure. One embodiment as heretofore described can be employed in the ceilings 910 of an interior or exterior structure such as, but not limited to, an elevator cab, as a light illuminating structure having LEDs, arrays of LEDs, light emitting fibers, lasers, or other luminaires or light emitting devices contained in an encompassed area defined by an exemplary backing frame. Other embodiments can be employed in ceilings or side panels 920 with displays or active displays contained in an encompassed area defined by an exemplary backing frame. Such an embodiment 920 can fully utilize the touch concept advantages of thin glass as heretofore described. Additional embodiments can be employed in side panels 930 having decorative features (e.g., pictures 931, marbling 932, solid colors 933, wood 934, and the like) and/or acoustic features. Of course, in these embodiments, the decoration can be ink jetted or otherwise deposited on an interior face of the respective panel or can be a portion of or all of the respective backing frame. It should be noted that the thinness and high transparency of embodiments of the present disclosure permit an image that is printed on the back surface to be seen as being directly on the surface of the front face of the glass. Apparent depth of decorative layers can thus be controlled by adding layers to the thickness of the decorative stack. Layers added by single or multiple lamination steps of two or more pieces of glass, plastic, interlayers, and decorative element are envisioned in embodiments of the present disclosure

Exemplary backing frames according to embodiments of the present disclosure can employ and accommodate any means of fixation to walls, elevator cabs, or other architectural structures including, but not limited to, removable and reconfigurable partitions for office spaces, lobbies, hallways, entryways, etc. Some of the non-limiting examples of such fixation mechanisms are tongue in groove type designs, clip designs, point bonding to glass such as the Guardian® spider fixtures, corner frame mortices, tapes, films and other adhesives (such as VHB series or the OCA series from 3M, TESA, Dow-Corning adhesives, Sika adhesives, or removable adhesives such as 3M quick release products) for direct bonding of the glass or glass laminate panel to existing walls or frames. Such connection and fixation mechanisms can also be employed to attach periphery and enabling technologies to exemplary embodiments of a glass or glass laminate panel.

Embodiments of the present disclosure are generally modular in design thus allowing for ease of replacement of panels should a panel fracture or be replaced due to aesthetic purposes. For example, changing an exemplary panel of solid color to one that is a touch display and/or acoustic panel of the same dimensions can minimize rework/refitting on site due to the construction of such embodiments, thus panel installation can be agnostic towards panel functionality. For embodiments requiring added stiffness, an exemplary panel construction can be made of multiple thin glass layers or a hybrid construction of thin chemically strengthened glass and thicker soda lime glass (annealed, heat strengthened, thermally tempered). Such a laminate construction can retain the strength, hardness and optical clarity of thin, chemically-strengthened glass (e.g., Gorilla® Glass) while still maintaining a lighter weight advantage over all conventional soda lime glass constructions.

While not shown, some embodiments of the present disclosure can include additional impact absorbing mechanisms such as, but not limited to, grommets and absorption pads (e.g., rubbers, silicones, elastic polymers, viscoelastic materials, and the like). These absorption mechanisms or pads can be positioned at supports and other impact absorbing points of contact improve the break resistance of the panel system. Sorbothane, polynorbornene, noene, astro-sorb, memory foam, and neoprene are some but not all examples of viscoelastic materials. Shear thickening materials in which viscosity increases with the rate of shear strain may also be used at strategic points to stiffen the structure during impact events.

It is thus an aspect of embodiments of the present disclosure to provide reconfigurable panels having lighter weight (installation, handling, shipping, processing during decoration), greater optical transmission in the optical range (maintain color purity of decorations), greater flexibility for decorative designs, enabled touch functionality, acoustic functionality (speakers or speaker/microphone combinations), scratch resistance and impact resistance in comparison to conventional solutions.

In some embodiments, a glass panel is provided having a glass structure with an exterior surface and an interior surface, the glass structure having at least one thin glass sheet with a thickness ranging from about 0.5 mm to about 2.0 mm and a backing frame positioned adjacent the glass structure and situated along the perimeter of the interior surface of the glass structure. The glass panel further includes a polymer layer positioned on the interior surface and intermediate the glass structure and backing frame to adhere the glass structure together with the backing frame and an acoustic exciter positioned on the glass structure, the acoustic exciter providing excitation energy to or receiving excitation energy from the glass structure. The acoustic exciter can be mounted on an edge or the interior surface of the glass structure. In some embodiments, the acoustic exciter further comprises an array of acoustic exciters positioned on the glass structure as a function of composition of the at least one thin glass sheet, thickness of the at least one thin glass sheet, number of glass sheets in the glass structure, number of polymer layers in the glass structure, composition of the polymer layer, thickness of the polymer layer, type of acoustic exciter, acoustic exciter characteristics, geometric shape of the glass structure, geometric shape of the at least one thin glass sheet, geometric shape of the polymer layer, level of compressive stress of the at least one thin glass sheet, depth of layer of compressive stress of the at least one thin glass sheet, and combinations thereof. Of course, the acoustic exciter can provide one-way or two-way communications. Exemplary acoustic exciters can be, but are not limited to, a speaker, a microphone, a transducer, a voice coil transducer, magnet transducer, motor transducer, electrostatic transducer, acousto-mechanical transducer, pneumatic transducer, thermal transducer, air transfer transducer, piezoelectric transducer, (Pb(Zr,Ti)O₃)-based transparent ceramic transducer, lanthanum-doped zirconium titanate (PLZT) transducer, (PbBa)(Zr,Ti)O₃, (PbSr)(ZrTi)O₃ and (PbCa)(ZrTi)O₃, barium titanate-based transducers, polyvinylidene fluoride (PVDF) transducer, poly-a-methyl-1-glutamate transducer, polyvinyl chloride (PVC) transducer, and poly tri-fluoro ethylene transducer. In some embodiments, the frequency response of the panel can be a function of the geometry of the glass structure, geometry of layers in the glass structure, the position the acoustic exciter, composition of layers in the glass structure, level of compressive stress of the at least one thin glass sheet, depth of layer of compressive stress of the at least one thin glass sheet, and combinations thereof. Exemplary glass structures can be flat or shaped. In some embodiments, the glass panel can include one or more partitions to create isolated acoustic panels on the glass structure. In some embodiments, the thickness of the at least one thin glass sheet ranges from about 0.5 to 1.5 mm, from 0.5 mm to about 1.0 mm or from about 0.5 mm to about 0.7 mm. In other embodiments, the glass structure further comprises the at least one thin glass sheet and a second glass sheet having a polymer interlayer intermediate the second glass sheet and the at least one thin glass sheet. This thin glass sheet can be a thin, chemically-strengthened glass sheet. In other embodiments, the second glass sheet can be, but is not limited to, a chemically-strengthened glass sheet, a thin chemically-strengthened glass sheet, a soda lime glass sheet, and a monolithic tempered glass sheet. Either the second glass sheet or the at least one thin glass sheet can be adjacent the backing frame. Exemplary polymer interlayers can be, but are not limited to, PVB, EVA, TPU, PET, and combinations thereof. In additional embodiments, exemplary backing frames can possess a cross-section such as, but not limited to, a substantially rectangular cross-section with a rounded interior edge adjacent the glass structure, a substantially square cross-section with a rounded interior edge adjacent the glass structure, a circular cross-section, a domed cross section, a substantially rectangular cross-section with rounded interior and exterior edges adjacent the glass structure, a substantially square cross-section with rounded interior and exterior edges adjacent the glass structure, asymmetrical cross-sections, and symmetrical cross-sections. It is also envisioned that exemplary glass panels further comprise a plurality of decorative film layers and can also include one or more coatings of material such as, but not limited to, an anti-glare material, anti-reflection material, anti-fingerprint material, anti-viral material, anti-bacterial material, anti-splinter material, and combinations thereof, provided on one or both planar surfaces of the glass structure. In some embodiments, the backing frame can define a space containing a device selected from the group consisting of a light source, a LED, an array of LEDs, a laser, a light emitting fiber, a luminaire, a display, electronic devices, and combinations thereof. Such exemplary glass panels can be installed in an interior environment selected from the group consisting of a wall, an elevator cab, a lobby, a ceiling, a hallway, an entryway, and a room. In additional embodiments, the backing frame can be comprised of a material such as, but not limited to, polyvinyl chloride, polycarbonate, glasses, phenolic material, steel, wood, aluminum, ceramics and combinations thereof. Further, the backing frame can include a honeycomb structure comprising a material selected from the group consisting of aluminum, steel, ceramic, polymer, graphite, carbon, and combinations thereof.

In other embodiments, a glass panel is provided having a glass structure with an exterior surface and an interior surface, the glass structure having at least one thin glass sheet with a thickness ranging from about 0.5 mm to about 2.0 mm and a backing frame positioned adjacent the glass structure and situated along the perimeter of the interior surface of the glass structure. The glass panel further includes a polymer layer positioned on the interior surface and intermediate the glass structure and backing frame to adhere the glass structure together with the backing frame an array of acoustic exciters positioned on the glass structure, the array of acoustic exciters providing excitation energy to or receiving excitation energy from the glass structure where frequency response of the panel can be a function of the geometry of the glass structure and the position of the acoustic exciters. The acoustic exciter(s) can be mounted on an edge or the interior surface of the glass structure. In some embodiments, the frequency response of the panel can be further determined as a function of composition of the at least one thin glass sheet, thickness of the at least one thin glass sheet, number of glass sheets in the glass structure, number of polymer layers in the glass structure, composition of the polymer layer, thickness of the polymer layer, type of acoustic exciter, acoustic exciter characteristics, depth of layer of compressive stress in the at least one thin glass sheet, level of compressive stress in the at least one thin glass sheet, and combinations thereof. Exemplary acoustic exciters can be, but are not limited to, a speaker, a microphone, a transducer, a voice coil transducer, magnet transducer, motor transducer, electrostatic transducer, acousto-mechanical transducer, pneumatic transducer, thermal transducer, air transfer transducer, piezoelectric transducer, (Pb(Zr,Ti)O₃)-based transparent ceramic transducer, lanthanum-doped zirconium titanate (PLZT) transducer, (PbBa)(Zr,Ti)O₃, (PbSr)(ZrTi)O₃ and (PbCa)(ZrTi)O₃, barium titanate-based transducers, polyvinylidene fluoride (PVDF) transducer, poly-a-methyl-1-glutamate transducer, polyvinyl chloride (PVC) transducer, and poly tri-fluoro ethylene transducer. Exemplary glass structures can be flat or shaped. In some embodiments, the glass panel can include one or more partitions to create isolated acoustic panels on the glass structure. In some embodiments, the thickness of the at least one thin glass sheet ranges from about 0.5 to 1.5 mm, from 0.5 mm to about 1.0 mm or from about 0.5 mm to about 0.7 mm. In other embodiments, the glass structure further comprises the at least one thin glass sheet and a second glass sheet having a polymer interlayer intermediate the second glass sheet and the at least one thin glass sheet. This thin glass sheet can be a thin, chemically-strengthened glass sheet. In other embodiments, the second glass sheet can be, but is not limited to, a chemically-strengthened glass sheet, a thin chemically-strengthened glass sheet, a soda lime glass sheet, and a monolithic tempered glass sheet. Either the second glass sheet or the at least one thin glass sheet can be adjacent the backing frame. Exemplary polymer interlayers can be, but are not limited to, PVB, EVA, TPU, PET, and combinations thereof. In additional embodiments, exemplary backing frames can possess a cross-section such as, but not limited to, a substantially rectangular cross-section with a rounded interior edge adjacent the glass structure, a substantially square cross-section with a rounded interior edge adjacent the glass structure, a circular cross-section, a domed cross section, a substantially rectangular cross-section with rounded interior and exterior edges adjacent the glass structure, a substantially square cross-section with rounded interior and exterior edges adjacent the glass structure, asymmetrical cross-sections, and symmetrical cross-sections. It is also envisioned that exemplary glass panels further comprise a plurality of decorative film layers and can also include one or more coatings of material such as, but not limited to, an anti-glare material, anti-reflection material, anti-fingerprint material, anti-viral material, anti-bacterial material, anti-splinter material, and combinations thereof, provided on one or both planar surfaces of the glass structure. In some embodiments, the backing frame can define a space containing a device selected from the group consisting of a light source, a LED, an array of LEDs, a laser, a light emitting fiber, a luminaire, a display, electronic devices, and combinations thereof. Such exemplary glass panels can be installed in an interior environment selected from the group consisting of a wall, an elevator cab, a lobby, a ceiling, a hallway, an entryway, and a room. In additional embodiments, the backing frame can be comprised of a material such as, but not limited to, polyvinyl chloride, polycarbonate, glasses, phenolic material, steel, wood, aluminum, ceramics and combinations thereof. Further, the backing frame can include a honeycomb structure comprising a material selected from the group consisting of aluminum, steel, ceramic, polymer, graphite, carbon, and combinations thereof.

While this description can include many specifics, these should not be construed as limitations on the scope thereof, but rather as descriptions of features that can be specific to particular embodiments. Certain features that have been heretofore described in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and can even be initially claimed as such, one or more features from a claimed combination can in some cases be excised from the combination, and the claimed combination can be directed to a subcombination or variation of a subcombination.

Similarly, while operations are depicted in the drawings or figures in a particular order, this should not be understood as requiring that such operations be performed in the particular order shown or in sequential order, or that all illustrated operations be performed, to achieve desirable results. In certain circumstances, multitasking and parallel processing can be advantageous.

As shown by the various configurations and embodiments illustrated in FIGS. 1-10, various embodiments for acoustic panels and planar structures have been described.

While some embodiments of the present disclosure have been described, it is to be understood that the embodiments described are illustrative only and that the scope of the invention is to be defined solely by the appended claims when accorded a full range of equivalence, many variations and modifications naturally occurring to those of skill in the art from a perusal hereof

What is claimed is:

1. A glass panel comprising:
a glass structure having an exterior surface and an interior surface, the glass structure having at least one glass sheet with a thickness ranging from about 0.5 mm to about 2.0 mm;
a backing frame positioned adjacent the glass structure and situated along the perimeter of the interior surface of the glass structure;
a polymer layer positioned on the interior surface and intermediate the glass structure and backing frame to adhere the glass structure together with the backing frame; and
an acoustic exciter positioned on the glass structure, the acoustic exciter providing excitation energy to or receiving excitation energy from the glass structure.

2. The glass panel of claim 1 wherein the acoustic exciter is mounted on an edge or the interior surface of the glass structure.

3. The glass panel of claim 1 wherein the acoustic exciter further comprises an array of acoustic exciters positioned on the glass structure as a function of composition of the at least one glass sheet, thickness of the at least one glass sheet, number of glass sheets in the glass structure, number of polymer layers in the glass structure, composition of the polymer layer, thickness of the polymer layer, type of acoustic exciter, acoustic exciter characteristics, geometric shape of the glass structure, geometric shape of the at least one glass sheet, geometric shape of the polymer layer, level of compressive stress of the at least one glass sheet, depth of layer of compressive stress of the at least one glass sheet, and combinations thereof.

4. The glass panel of claim 1 wherein the acoustic exciter provides one-way or two-way communications.

5. The glass panel of claim 1 wherein the acoustic exciter is selected from the group consisting of a speaker, a microphone, a transducer, a voice coil transducer, magnet transducer, motor transducer, electrostatic transducer, acousto-mechanical transducer, pneumatic transducer, thermal transducer, air transfer transducer, piezoelectric transducer, (Pb(Zr,Ti)O₃)-based transparent ceramic transducer, lanthanum-doped zirconium titanate (PLZT) transducer, (PbBa)(Zr,Ti)O₃, (PbSr)(ZrTi)O₃ and (PbCa)(ZrTi)O₃, barium titanate-based transducers, polyvinylidene fluoride (PVDF) transducer, poly-a-methyl-1-glutamate transducer, polyvinyl chloride (PVC) transducer, and poly tri-fluoro ethylene transducer.

6. The glass panel of claim 3 wherein the acoustic exciters in the array are selected from the group consisting of a speaker, a microphone, a transducer, a voice coil transducer, magnet transducer, motor transducer, electrostatic transducer, acousto-mechanical transducer, pneumatic transducer, thermal transducer, air transfer transducer, piezoelectric transducer, (Pb(Zr,Ti)O₃)-based transparent ceramic transducer, lanthanum-doped zirconium titanate (PLZT) transducer, (PbBa)(Zr,Ti)O₃, (PbSr)(ZrTi)O₃ and (PbCa)(ZrTi)O₃, barium titanate-based transducers, polyvinylidene fluoride (PVDF) transducer, poly-a-methyl-1-glutamate transducer, polyvinyl chloride (PVC) transducer, poly tri-fluoro ethylene transducer, and combinations thereof.

7. The glass panel of claim 1 wherein the frequency response of the panel is a function of the geometry of the glass structure, geometry of layers in the glass structure, the position the acoustic exciter, composition of layers in the glass structure, level of compressive stress of the at least one glass sheet, depth of layer of compressive stress of the at least one glass sheet, and combinations thereof.

8. The glass panel of claim 1 wherein the glass structure is flat or shaped.

9. The glass panel of claim 1 further comprising one or more partitions to create isolated acoustic panels on the glass structure.

10. The glass panel of claim 1 wherein the thickness of the at least one glass sheet ranges from about 0.5 mm to about 1.5 mm, from about 0.5 mm to about 1.0 mm or from about 0.5 mm to about 0.7 mm.

11. The glass panel of claim 1 wherein the glass structure further comprises the at least one glass sheet and a second glass sheet having a polymer interlayer intermediate the second glass sheet and the at least one glass sheet.

12. The glass panel of claim 11 wherein the at least one glass sheet is a thin, chemically-strengthened glass sheet.

13. The glass panel of claim 12 wherein the second glass sheet is selected from the group consisting of a chemically-strengthened glass sheet, a chemically-strengthened glass sheet, a soda lime glass sheet, and a monolithic tempered glass sheet.

14. The glass panel of claim 13 wherein the second glass sheet is adjacent the backing frame.

15. The glass panel of claim 13 wherein the at least one glass sheet is adjacent the backing frame.

16. The glass panel of claim 11 wherein the polymer interlayer is selected from the group consisting of polyvinyl butyral (PVB), ethylene vinyl acetate (EVA), thermoplastic polyurethane (TPU), polyethylene terephthalate (PET), and combinations thereof.

17. The glass panel of claim 1 wherein the backing frame has a cross-section selected from the group consisting of a substantially rectangular cross-section with a rounded interior edge adjacent the glass structure, a substantially square cross-section with a rounded interior edge adjacent the glass structure, a circular cross-section, a domed cross section, a substantially rectangular cross-section with rounded interior and exterior edges adjacent the glass structure, a substantially square cross-section with rounded interior and exterior edges adjacent the glass structure, asymmetrical cross-sections, symmetrical cross-sections.

18. The glass panel of claim 1 further comprising a plurality of decorative film layers.

19. The glass panel of claim 1 further comprising one or more coatings of material selected from the group consisting of an anti-glare material, anti-reflection material, anti-fingerprint material, anti-viral material, anti-bacterial material, anti-splinter material, and combinations thereof, provided on one or both planar surfaces of the glass structure.

20. The glass panel of claim 1 wherein the backing frame defines a space containing a device selected from the group consisting of a light source, a light emitting diode (LED), an array of LEDs, a luminaire, a light emitting fiber, a laser, a display, electronic devices, and combinations thereof.

21. The glass panel of claim 1 wherein the panel is installed in an interior environment selected from the group consisting of a wall, an elevator cab, a lobby, a ceiling, a hallway, an entryway, and a room.

22. The glass panel of claim 1 wherein the backing frame is comprised of a material selected from the group consisting of polyvinyl chloride, polycarbonate, phenolic material, steel, glass, wood, aluminum, ceramic and combinations thereof.

23. The glass panel of claim 1 wherein the backing frame includes a honeycomb structure comprising a material selected from the group consisting of aluminum, steel, ceramic, polymer, graphite, carbon, and combinations thereof.

24. A glass panel comprising
a glass structure having an exterior surface and an interior surface, the glass structure having at least one glass sheet with a thickness ranging from about 0.5 mm to about 2.0 mm;
a backing frame positioned adjacent the glass structure and situated along the perimeter of the interior surface of the glass structure;
a polymer layer positioned on the interior surface and intermediate the glass structure and backing frame to adhere the glass structure together with the backing frame; and
an array of acoustic exciters positioned on the glass structure, the array of acoustic exciters providing excitation energy to or receiving excitation energy from the glass structure,
wherein frequency response of the panel is a function of the geometry of the glass structure and the position of the acoustic exciters.

25. The glass panel of claim 24 wherein the acoustic exciters are mounted on an edge of the glass structure, the interior surface of the glass structure, or both.

26. The glass panel of claim 24 wherein the frequency response of the panel is further determined as a function of composition of the at least one glass sheet, thickness of the at least one glass sheet, number of glass sheets in the glass structure, number of polymer layers in the glass structure, composition of the polymer layer, thickness of the polymer layer, type of acoustic exciter, acoustic exciter characteristics, depth of layer of compressive stress in the at least one glass sheet, level of compressive stress in the at least one glass sheet, and combinations thereof.

27. The glass panel of claim 24 wherein the acoustic exciters in the array are selected from the group consisting of a transducer, a voice coil transducer, magnet transducer, motor transducer, electrostatic transducer, acousto-mechanical transducer, pneumatic transducer, thermal transducer, air transfer transducer, piezoelectric transducer, (Pb(Zr,Ti)O₃)-based transparent ceramic transducer, lanthanum-doped zirconium titanate (PLZT) transducer, (PbBa)(Zr,Ti)O₃, (PbSr)(ZrTi)O₃ and (PbCa)(ZrTi)O₃, barium titanate-based transducers, polyvinylidene fluoride (PVDF) transducer, poly-a-methyl-1-glutamate transducer, polyvinyl chloride (PVC) transducer, poly tri-fluoro ethylene transducer, and combinations thereof.

28. The glass panel of claim 24 wherein the glass structure is flat or shaped.

29. The glass panel of claim 24 further comprising one or more partitions to create isolated acoustic panels on the glass structure.

30. The glass panel of claim 24 wherein the thickness of the at least one glass sheet ranges from about 0.5 mm to about 1.5 mm, from about 0.5 mm to about 1.0 mm or from about 0.5 mm to about 0.7 mm.

31. The glass panel of claim 24 wherein the glass structure further comprises the at least one glass sheet and a second glass sheet having a polymer interlayer intermediate the second glass sheet and the at least one glass sheet.

32. The glass panel of claim 31 wherein the at least one glass sheet is a thin, chemically-strengthened glass sheet.

33. The glass panel of claim 32 wherein the second glass sheet is selected from the group consisting of a chemically-strengthened glass sheet, a chemically-strengthened glass sheet, a soda lime glass sheet, and a monolithic tempered glass sheet.

34. The glass panel of claim 33 wherein the second glass sheet is adjacent the backing frame.

35. The glass panel of claim 33 wherein the at least one glass sheet is adjacent the backing frame.

36. The glass panel of claim 31 wherein the polymer interlayer is selected from the group consisting of polyvinyl butyral (PVB), ethylene vinyl acetate (EVA), thermoplastic polyurethane (TPU), polyethylene terephthalate (PET), and combinations thereof.

37. The glass panel of claim 24 wherein the backing frame has a cross-section selected from the group consisting of a substantially rectangular cross-section with a rounded interior edge adjacent the glass structure, a substantially square cross-section with a rounded interior edge adjacent the glass structure, a circular cross-section, a domed cross section, a substantially rectangular cross-section with rounded interior and exterior edges adjacent the glass structure, a substantially square cross-section with rounded interior and exterior edges adjacent the glass structure, asymmetrical cross-sections, symmetrical cross-sections.

38. The glass panel of claim 24 further comprising a plurality of decorative film layers.

39. The glass panel of claim 24 further comprising one or more coatings of material selected from the group consisting of an anti-glare material, anti-reflection material, anti-fingerprint material, anti-viral material, anti-bacterial material, anti-splinter material, and combinations thereof, provided on one or both planar surfaces of the glass structure.

40. The glass panel of claim 24 wherein the backing frame defines a space containing a device selected from the group consisting of a light source, a light emitting diode (LED), an array of LEDs, a luminaire, a light emitting fiber, a laser, a display, electronic devices, and combinations thereof.

41. The glass panel of claim 24 wherein the panel is installed in an interior environment selected from the group consisting of a wall, an elevator cab, a lobby, a ceiling, a hallway, an entryway, and a room.

42. The glass panel of claim 24 wherein the backing frame is comprised of a material selected from the group consisting of polyvinyl chloride, polycarbonate, phenolic material, steel, glass, wood, aluminum, ceramic and combinations thereof.

43. The glass panel of claim 24 wherein the backing frame includes a honeycomb structure comprising a material selected from the group consisting of aluminum, steel, ceramic, polymer, graphite, carbon, and combinations thereof.
